(19) United States
(12) Patent Application Publication
(10) Pub. No.: US 2013/0336696 A1
(43) Pub. Date: Dec. 19, 2013

(54) AUTOMATIC DOCUMENT FEEDER AND MEDIA RECORD EQUIPMENT USING THE SAME

(71) Applicants: Michael Medrano Recinto, Singapore (SG); Domingo Jr. Abao Vicente, Singapore (SG); Cher-Lek Toh, Singapore (SG); Chen-Fu Huang, New Taipei City (TW); Harold Magtibay Cabral, Singapore (SG)

(72) Inventors: Michael Medrano Recinto, Singapore (SG); Domingo Jr. Abao Vicente, Singapore (SG); Cher-Lek Toh, Singapore (SG); Chen-Fu Huang, New Taipei City (TW); Harold Magtibay Cabral, Singapore (SG)

(73) Assignees: Cal-Comp Electronics & Communications Company Limited, New Taipei City (TW); Cal-Comp Precision (Singapore) Limited, Singapore (SG)

(21) Appl. No.: 13/551,577

(22) Filed: Jul. 17, 2012

(30) Foreign Application Priority Data
Jun. 19, 2012 (SG) 201204538-1

(51) Int. Cl. G03G 15/00

(52) U.S. Cl. 399/367

(57) ABSTRACT

An automatic document feeder and a media record equipment using the same are provided. The automatic document feeder includes a frame, a cover and a gear chain. An end of the cover pivoted to the frame has a cam. The gear chain disposed in the frame has multiple driven gears and a rotating unit. The driven gears engaged with each other rotate about a first axial direction. The rotating unit having a first rock arm contacting the cam and a second rock arm with one of the driven gears disposed thereon is capable of rotating about the first axial direction. The cam pushes the first rock arm to drive the rotating unit to rotate about the first axial direction, and then an engagement between the driven gear on the second rock arm is released by departing from another driven gear engaged therewith when the cover opens relative to the frame.

### CROSS-REFERENCE TO RELATED APPLICATION

This application claims the priority benefit of Singapore application serial no. 201204538-1, filed on Jun. 19, 2012. The entirety of the above-mentioned patent application is hereby incorporated by reference herein and made a part of this specification.

### BACKGROUND OF THE INVENTION

1. Field of the Disclosure

The present invention is related to an automatic document feeder and a media record equipment, and more particularly, to an automatic document feeder and a media record equipment with convenience of jam releasing for a user.

2. Description of Related Art

Different sorts of electronic devices have been gradually developed and become necessary tools in daily lives. For example, equipments such as computers, printers, fax machines and photocopiers are configured in an office for document processing. Work efficiency of printers, photocopiers and fax machines related to paper are influenced by faculty of paper feeding.

Take the multi-function printer compatible of print and photocopy as an example, an automatic document feeder (ADF) disposed on the multi-function printer is used to feed blank paper into the multi-function printer for printing or photocopying. A user often puts a stack of paper in a paper tray of the ADF device before copying, printing, or scanning When copying, printing or scanning is performed, paper is transmitted in the multi-function printer by ADF, and then images are formed on paper through the printer.

FIG. 1 is a schematic view of a conventional paper feeding device, and FIG. 2 is a perspective view of inner of the paper feeding device of FIG. 1. Referring to FIGS. 1 and 2, the conventional paper feeding device includes a feeding roller 10, a separate roller 20, a scan roller 30, a scan module 40, an eject roller 50, a first gear chain 60, a motor 70, a second gear chain 80 and a jam release device 90. By means of the motor 70 to drive the first gear chain 60, the second gear chain 80 and multiple connecting rollers, after paper 1 is transferred to the conventional paper feeding device, paper 1 passes through the feeding roller 10, the separate roller 20, the scan roller 30 and the scan module 40 orderly, and then is ejected outside of the main body of the paper feeding device by the eject roller 50. The cover of the conventional paper feeding device has to be opened when paper 1 is jammed between the feeding roller 10 and the separate roller 20 for a user to release the jammed paper 1. In detail, a user rotates the jam release device 90 to release the paper 1 jammed between the scan roller 30 and the eject roller 50, so as to eject the jammed paper 1.

However, due to tight engagement between the feeding roller 10, the separate roller 20, the scan roller 30, the motor 70 and the second gear chain 80, even when the motor 70 stops operating, it is still hard for the user to release the paper jammed between the rollers.

### SUMMARY OF THE DISCLOSURE

The invention provides an automatic document feeder (ADF) with jam release function which is convenient in use.

The invention provides a media record equipment having the above-mentioned ADF with jam release function which is convenient in use.

The present invention provides an automatic document feeder including a frame, a cover and a gear chain. An end of the cover is pivoted to the frame and therefore the cover could be open or close relative to the frame, and the end of the cover pivoted to frame has a cam. The gear chain disposed in the frame has multiple driven gears and a rotating unit. The driven gears engage with each other and are disposed with a first axial direction as a rotating axle. The rotating unit is also disposed with the first axial direction as the rotating axle and has a first rock arm and a second rock arm, wherein the cam contacts the first rock arm and one of the driven gears is disposed on the second rock arm. The cam pushes the first rock arm to drive the rotating unit to rotate about the first axial direction, and then an engagement between the driven gear disposed on the second rock arm and another driven gear engaged therewith is released by departing the driven gear disposed on the second rock arm from the driven gear engaged therewith when the cover opens relative to the frame.

In one embodiment of the automatic document feeder, wherein the first rock arm has an L-shaped opening, and the cam is located in the L-shaped opening when the cover is close to the frame.

In one embodiment of the automatic document feeder, wherein the cam is a shaft, and the shaft distances from the corner of the L-shaped opening when the cover is close to the frame.

In one embodiment of the automatic document feeder, wherein the cover has a propping element while the first rock arm has a first guiding arc, and the propping element props the first rock arm when the cover is close to the frame. The propping element moves along a profile of the guiding arc when the cover is open to the frame.

In one embodiment of the automatic document feeder, wherein the first rock arm has a U-shaped opening while the cam is a shaft, and the shaft is located in the U-shaped opening when the cover is close to the frame.

In one embodiment of the automatic document feeder, wherein the cam has a first tooth portion, the first rock arm has a second tooth portion, and the first tooth portion is engaged with the second tooth portion.

In one embodiment of the automatic document feeder, the gear chain further comprises a driving gear disposed with a second axial direction perpendicular to the first axial direction as the rotating axle, and the driving gear is engaged with one of the driven gears.

In one embodiment of the automatic document feeder, wherein the driven gear engaged with the driving gear is different from the driven gear disposed on the second rock arm.

In one embodiment of the automatic document feeder, further comprising a plurality of fixing units while the frame has a plurality of fixing structures disposed around outside of the driven gears, wherein the fixing structures are apertures, and the fixing units such as screws or bolts pass through the fixing structures individually.

In one embodiment of the automatic document feeder, further comprising an elastic element connected between the first rock arm and the frame, wherein the elastic element is a spring or a rubber band, each of a bottom of the frame and the first rock arm has a hook ring, and two ends of the elastic element connect to the hook rings individually.

The invention further provides a media record equipment including a main body and an automatic document feeder disposed on the main body. The automatic document feeder includes a frame, a cover and a gear chain, wherein an end of the cover is pivoted to the frame and therefore the cover could be open or close relative to the frame, and the end of the cover pivoted to frame has a cam. The gear chain disposed in the frame has multiple driven gears and a rotating unit. The driven gears engage with each other and are disposed with a first axial direction as a rotating axle. The rotating unit is also disposed with the first axial direction as the rotating axle and has a first rock arm and a second rock arm, wherein the cam contacts the first rock arm and one of the driven gears is disposed on the second rock arm. The cam pushes the first rock arm to drive the rotating unit to rotate about the first axial direction, and then an engagement between the driven gear disposed on the second rock arm and another driven gear engaged therewith is released by departing the driven gear disposed on the second rock arm from the driven gear engaged therewith when the cover opens relative to the frame.

In one embodiment of the media record equipment, wherein the first rock arm has an L-shaped opening, and the cam is located in the L-shaped opening when the cover is close to the frame.

In one embodiment of the media record equipment, wherein the cam is a shaft, and the shaft distances from the corner of the L-shaped opening when the cover is close to the frame.

In one embodiment of the media record equipment, wherein the cover has a propping element while the first rock arm has a first guiding arc, and the propping element props the first rock arm when the cover is close to the frame. The propping element moves along a profile of the guiding arc when the cover is open to the frame.

In one embodiment of the media record equipment, wherein the first rock arm has a U-shaped opening while the cam is a shaft, and the shaft is located in the U-shaped opening when the cover is close to the frame.

In one embodiment of the media record equipment, wherein the cam has a first tooth portion, the first rock arm has a second tooth portion, and the first tooth portion is engaged with the second tooth portion.

In one embodiment of the media record equipment, wherein the gear chain further comprises a driving gear disposed with a second axial direction perpendicular to the first axial direction as the rotating axle, and the driving gear is engaged with one of the driven gears.

In one embodiment of the media record equipment, wherein the driven gear engaged with the driving gear is different from the driven gear disposed on the second rock arm.

In one embodiment of the media record equipment, further comprising a plurality of fixing units while the frame has a plurality of fixing structures disposed around outside of the driven gears, wherein the fixing structures are apertures, and the fixing units such as screws or bolts pass through the fixing structures to fix the frame on the main body.

In one embodiment of the media record equipment, further comprising an elastic element connected between the first rock arm and the frame, wherein the elastic element is a spring or a rubber band, each of a bottom of the frame and the first rock arm has a hook ring, and two ends of the elastic element connect to the hook rings individually.

Based on the above disclosure, in the automatic document feeder and the media record equipment using the same of the present invention, a cam is disposed on an end the cover to interfere the rotating unit, and therefore when the cover is open relative to the frame, the rotation of the cam drives the rotating unit to rotate, so as to release the engagement between the driven gear disposed on the rotating unit and another driven gear engaged therewith. Thereby, the rest of the driven gears of the gear chain can rotate freely, and the user can easily and conveniently release the paper jammed in the driven gears of the gear chain.

In order to make the aforementioned features and advantages of the invention more comprehensible, embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a conventional paper feeding device.

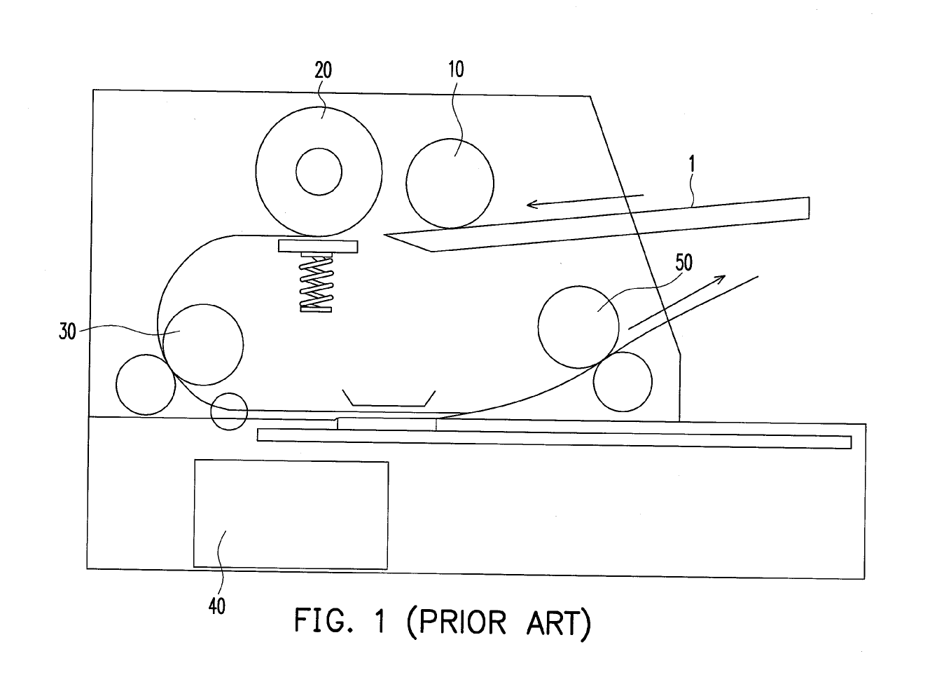

FIG. 2 is a perspective view of inner of the paper feeding device of FIG. 1.

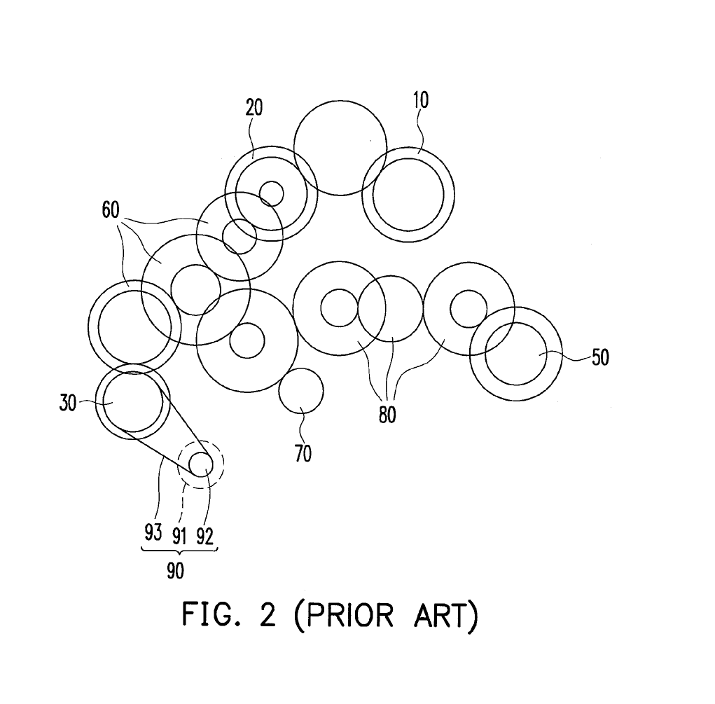

FIG. 3 is a schematic view of a media record equipment according to a first embodiment.

FIG. 4 is an exploded view of an automatic document feeder of the media record equipment in FIG. 3.

FIG. 5 is a schematic view of an assembly of the automatic document feeder in FIG. 4.

FIG. 6 is a partial view of the assembly of the automatic document feeder in FIG. 4.

FIG. 7 is a schematic view of the driven gear disposed on the second rock arm departs from the driven gear engaged therewith of the automatic document feeder in FIG. 5.

FIG. 8 is a partial schematic view illustrating an automatic document feeder with a cover closing according to a second embodiment.

FIG. 9 is a schematic view illustrating the cover of the automatic document feeder in FIG. 8 is open.

FIG. 10 is a schematic view of an automatic document feeder according to a third embodiment.

FIG. 11 is a schematic view illustrating an automatic document feeder with a cover is close according to a fourth embodiment.

FIG. 12 is a schematic view illustrating the cover of the automatic document feeder according to a FIG. 11 is opening.

FIG. 13 is a schematic view illustrating the cover of the automatic document feeder according to a FIG. 12 is open.

### DETAILED DESCRIPTION OF THE EMBODIMENTS

### First Embodiment

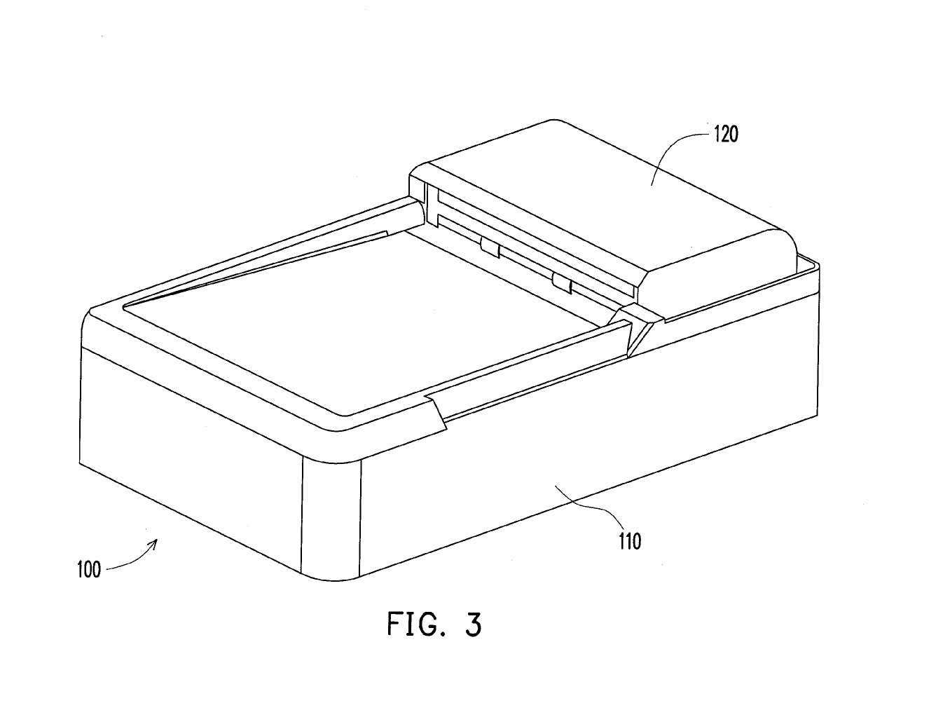

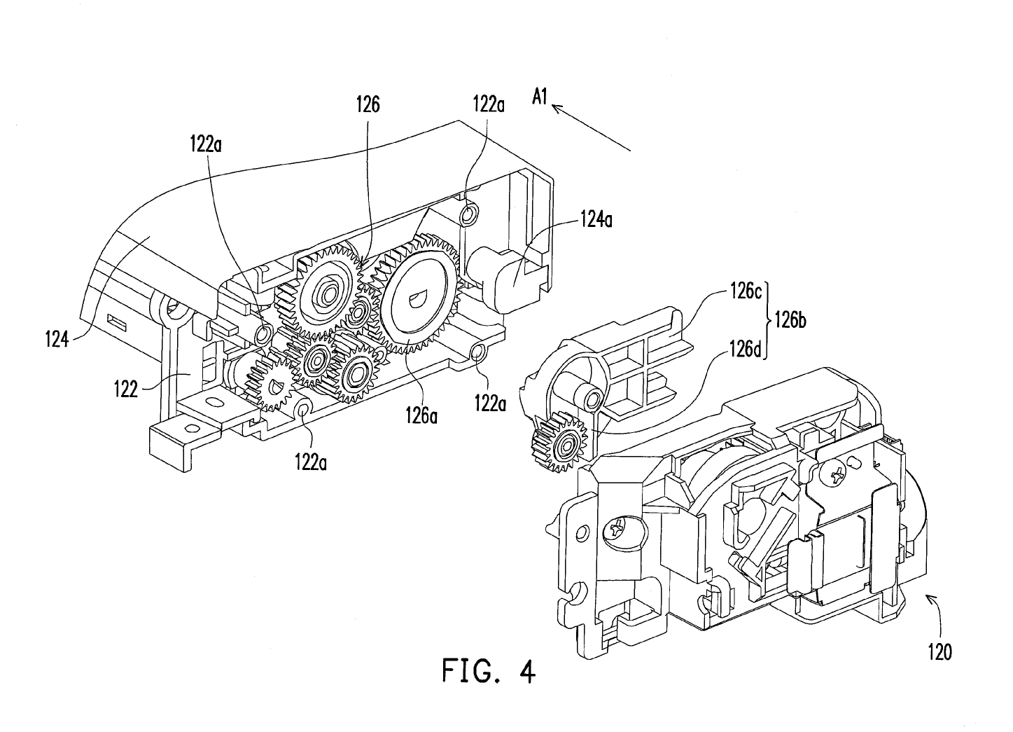

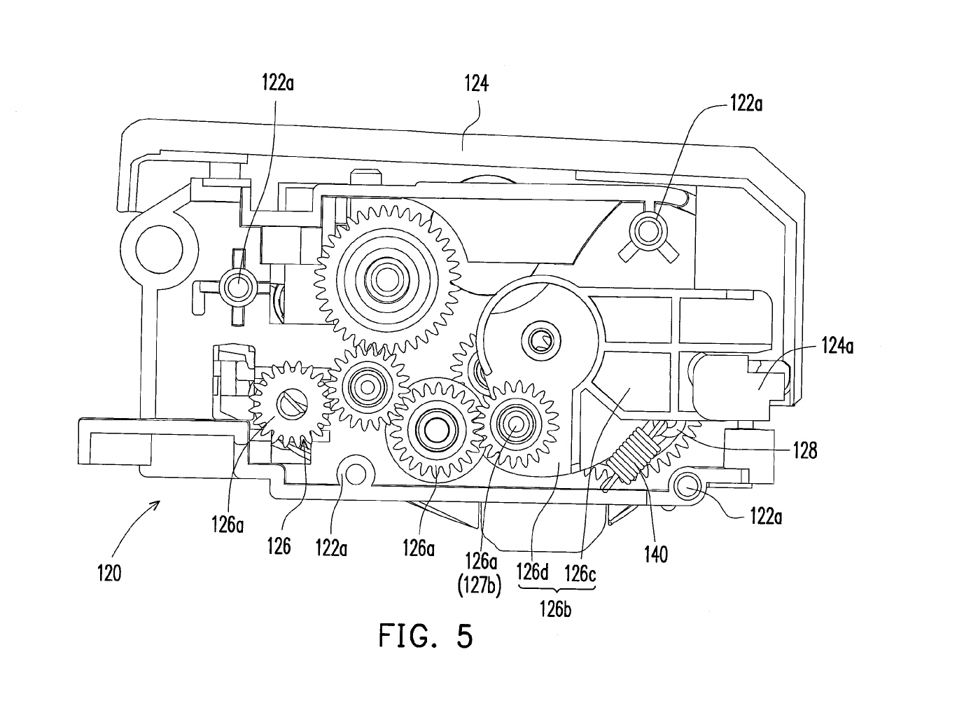

FIG. 3 is a schematic view of a media record equipment according to a first embodiment of the present invention. FIG. 4 is an exploded view of an automatic document feeder of the media record equipment in FIG. 3. FIG. 5 is a schematic view of an assembly of the automatic document feeder in FIG. 4. Referring to FIGS. 3 to 5, the media record equipment 100 includes a main body 110 and an automatic document feeder 120 disposed on the main body 110. The automatic document feeder 120 includes a frame 122, a cover 124 and a gear chain 126, wherein an end of the cover 124 is pivoted to the frame 122 and therefore the cover 124 could be open or close relative to the frame 122, and the end of the cover 124 pivoted to frame 122 has a cam 124a. The gear chain 126 disposed in the frame 122 includes a plurality of driven gears 126a and a rotating unit 126b, wherein the driven gears 126a are disposed with the first axial direction Al as a rotating axle, and the driven gears 126a engage with each other when the cover 124 is close relative to the frame 122. The rotating unit 126b is also disposed with the first axial direction Al as the rotating axle and having a first rock arm 126c and a second rock arm 126d, wherein the cam 124a contacts the first rock arm 126c and one of the driven gear 126a is disposed on the second rock arm 126d.

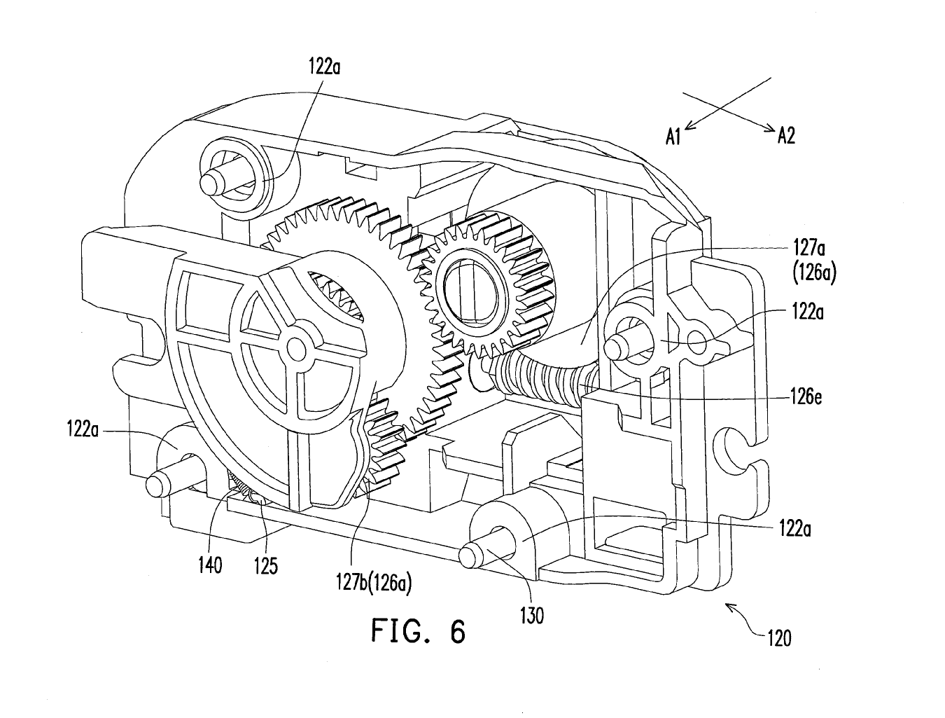

FIG. 6 is a partial view of the assembly of the automatic document feeder in FIG. 4. Referring to FIGS. 4 to 6, the gear chain 126 of the present embodiment further comprises a driving gear 126e disposed with a second axial direction A2 perpendicular to the first axial direction A1 as the rotating axle. The driving gear 126e is a worm wheel connected to the motor (not shown) and engages with one of the driven gear 126a. The moment output by the motor (not shown) is transferred through the driving gear 126e to a driven gear 126a engaged with the driving gear 126e, such that the driven gears 126a engaged with each other start to rotate and the automatic document feeder 120 starts to feed paper.

In the present embodiment, the driven gear 126a engaged with the driving gear 126e is different from the driven gear 126a disposed on the second rock arm 126d, and therefore the reference number of the driven gear 126a engaged with the driving gear 126e is labeled as 127a for distinguishing from the driven gear 126a disposed on the second rock arm 126d labeled as 127b. Herein, the difference between the driven gears 127a and 127b means that the driven gears 127a, 127b are in different locations, and therefore each of the driven gears 127a, 127b is engaged with different driven gears 126a. Rotating directions such as counterclockwise or clockwise of the driven gears 126a and a rotating sequence of the driven gears 126a of the gear chain 126 are related to individual locations of the driven gears 126a and related to a rotating direction of the driving gear 126e. The driven gears 126a applied in the gear chain 126 may have same or different shape, size and tooth distance, which depends on actual requirements and is not limited by the present application. In other embodiments not illustrated in figs, the driven gear 126a engaged with the driving gear 126e can also be the same driven gear 126a that is disposed on the second rock arm 126d. Persons having ordinary skill in the art can change locations of correlative elements by adapted modifications.

Furthermore, since the frame 122 needs to be fixed on the main body 110, the frame 122 of the present embodiment further has a plurality of fixing structures 122a disposed around outside of the driven gears 126a. The fixing structures 122a in the present embodiment are apertures, and correspondingly, the media record equipment 100 further has a plurality of fixing units 130, wherein the fixing units 130 pass through the fixing structures 122a to fix the frame 122 onto the main body 110. The fixing units 130 applied in the embodiment may be selected from screws or bolts, depends on actual requirements. Though the fixing units 130 applied in the embodiment are screws and bolts, and the fixing structures 122a applied in the embodiment are apertures, persons skilled in the art know that manners of fixing the frame 122 on the main body 110 are not limited by the present embodiment, and the frame 122 may also be fixed on the main body 110 by wedging, tight fastening, . . . etc.

The motor (not illustrated) drives the driving gear 126e to rotate when the media record equipment 100 starts photocopying or printing, the driven gear 127a engaged with the driving gear 126e is driven by the driving gear 126e to rotate and further to drive other driven gears 126a engaged with each other to rotate. Therefore, the automatic document feeder 120 starts to feed and transfer paper.

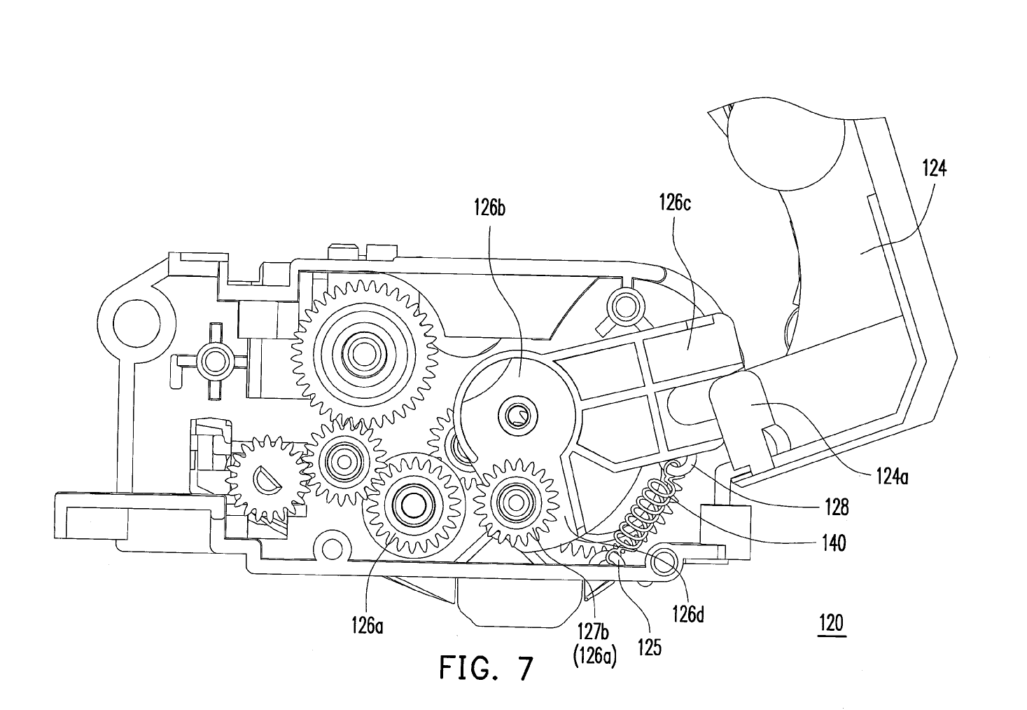

However, when the paper is jammed in the automatic document feeder 120, the user has to eject the paper from the automatic document feeder 120. In particularly, the user only has to open the cover 124 relative to the frame 122, and therefore the cam 124a interfered with the first rock arm 126c of the rotating element 126b rotates with the rotation of the cover 124 and pushes the first rock arm 126a simultaneously, and thus the rotating element 126b rotates about the first axial direction Al counterclockwise. Thus, the second rock arm 126d also rotates counterclockwise and departs from the driven gear 126a due to the rotation of the rotating element 126b, and such that an engagement between the driven gear 172b disposed on the second rock arm 126d and another driven gear 126a is released. Simply speaking, with the rotation of the rotating element 126b, the driven gear 127b disposed on the second rock arm 126d departs from the driven gear 126a that originally engaged therewith, as shown in FIG. 7.

After the driven gear 127b departs from the driven gear 126a engaged therewith, the motive force transferred by the gear chain 126 cannot be transferred anymore because of the lack of the driven gear 127b (may be considered as a connector between the driven gears). Thus, a tightly connecting relation is broken, and the rest of the driven gears 126e are free floating for the user to release paper jam conveniently.

As mentioned above, when paper jam is occurred in the automatic document feeder 120 or in the media record equipment 100 using the same, only one step that the user has to perform is to open the cover 124 relative to the frame 122, the cam 124a disposed on the cover 124 starts to rotate with the rotation of the cover 124 and drives the rotating element 126b to rotate, and further the driven gear 127b disposed on the second rock arm 126d of the rotating element 126b is departed from the driven gear 126a engaged therewith, and therefore the tightly engagement between the driven gears 126a of the gear chain 126 is released and the rest of the driven gears 126a can rotate freely such that the user can eject jammed paper conveniently. As such, the user ejects the jammed paper from the driven gears 126a with free rotating manner in only one step of opening the cover 124 and pulling the paper with labor-saving.

Referring to FIG. 5, the first rock arm 126c and the second rock arm 126d of the rotating element 126b are perpendicular to each other in substance, but the angle included between the first rock arm 126c and the second rock arm 126d is not limited by the present embodiment and could be changed according to actual requirements. Ever when the first rock arm 126c is interfered by the cam 124a to rotate, it falls in the scope of the automatic document feeder 120 and the media record equipment 100 using the same of the present invention.

Referring to FIGS. 5-7, the media record equipment 100 further comprises an elastic element 140 connected between the first rock arm 126c and the frame 122, wherein the elastic element 140 is a spring or a rubber band. A hook ring 125 is disposed on a bottom of the frame 122 (as shown in FIG. 6) while the first rock arm 126c has a hook ring 128 (as shown in FIG. 5), too, and two ends of the elastic element 140 connected to the hook rings 125 and 128 individually. After jam released, the user close the cover 124 relative to the frame 122, wherein the rotating element 126b may go back to a generally original location by self-weight, but the driven gear 127b disposed on the second rock arm 126d could not engage with the driven gear 126a tightly. Thus, the elastic element 140 connected between the rotating 126b and the frame 122 can drive the rotating element 126b back to the original location precisely by elastic force and make the driven gear 127b disposed on the second rock arm 126d engage with the driven gear tightly.

### Second Embodiment

The second embodiment is similar to the first embodiment, and elements that are equivalent or alike use equivalent or alike references.

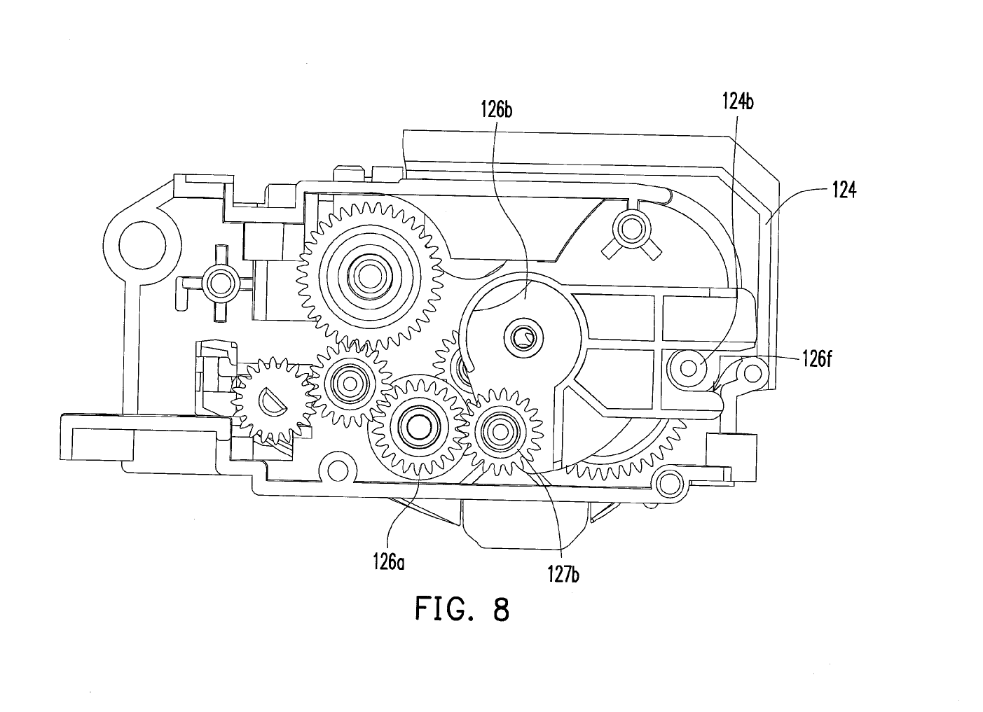

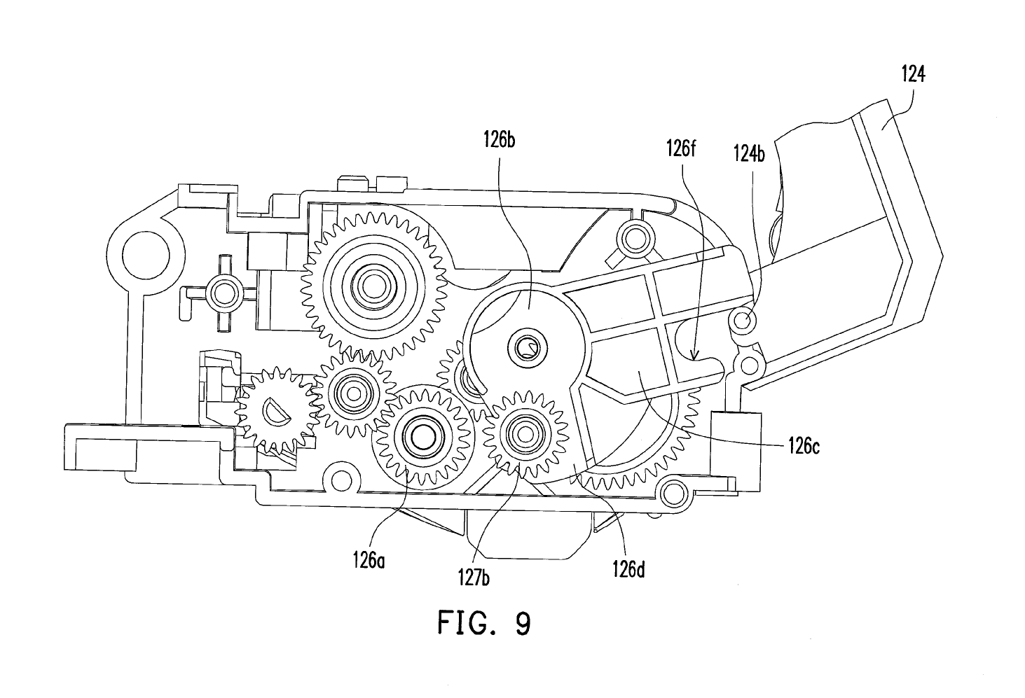

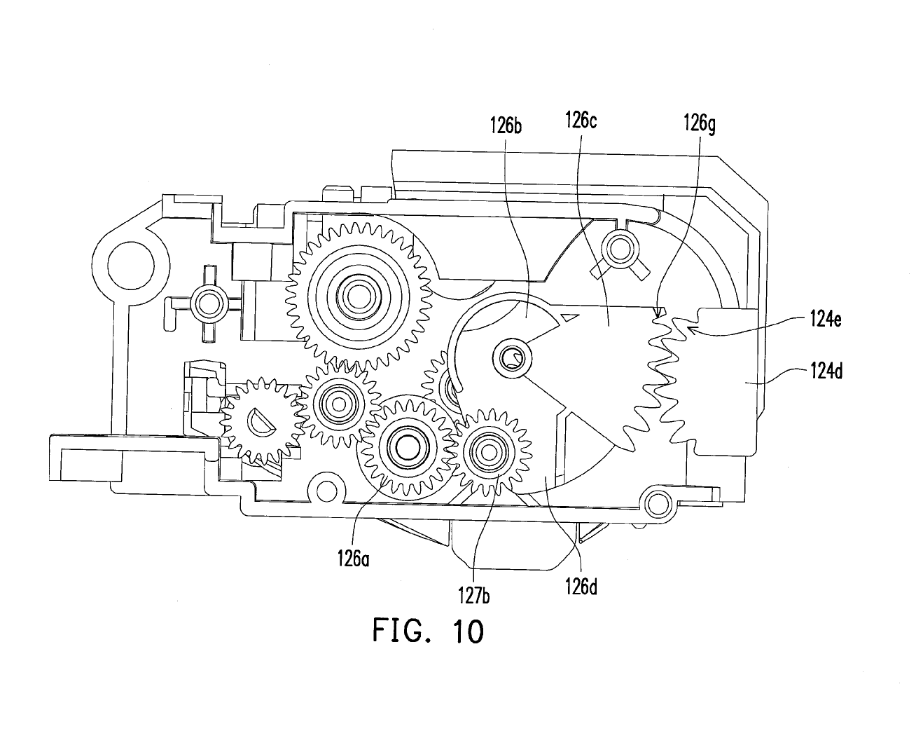

FIG. 8 is a partial schematic view illustrating an automatic document feeder with a cover closing according to a second embodiment. Referring to FIG. 8, the cam in the present embodiment is a shaft 124b, and the first rock arm 126c has an U-shaped opening 126f, wherein the shaft 124b is located in the U-shaped opening 126f when the cover 124 is close relative to the frame 122 (as shown in FIG. 4). FIG. 9 is a schematic view illustrating the cover of the automatic document feeder in FIG. 8 is open. Referring to FIGS. 9-10, the shaft 124b located in the U-shaped opening 126f moves relative to the rotating unit 126b along a profile of the U-shaped opening 126f, and props the U-shaped opening 126f when the cover 124 opens relative to the frame 122. The rotating unit 126b rotates about the first axial direction Al, and the driven gear 127b disposed on the second rock arm 126d moves away from the driven gear 126a.

### Third Embodiment

The third embodiment is similar to the above embodiments, and elements that are equivalent or alike use equivalent or alike references.

FIG. 10 is a schematic view of an automatic document feeder according to a third embodiment. Referring to FIG. 10, the difference between the present embodiment and the above two embodiments is that: the cam 124d of the present embodiment has a first tooth portion 124e, and the first rock arm 126c of the rotating unit 126b has a second tooth portion 126g, and the first tooth portion 124e engages with the second tooth portion 126g. Through the engagement between the first tooth portion 124e and the second tooth portion 126g, the rotating unit 126b rotates with the opening of the cover 124 relative to the frame 122, and the engagement between the driven gear 127b disposed on the second rock arm 126d and the driven 126a is released; therefore the jammed paper is ejected.

### Fourth Embodiment

The third embodiment is similar to the above embodiments, and elements that are equivalent or alike use equivalent or alike references.

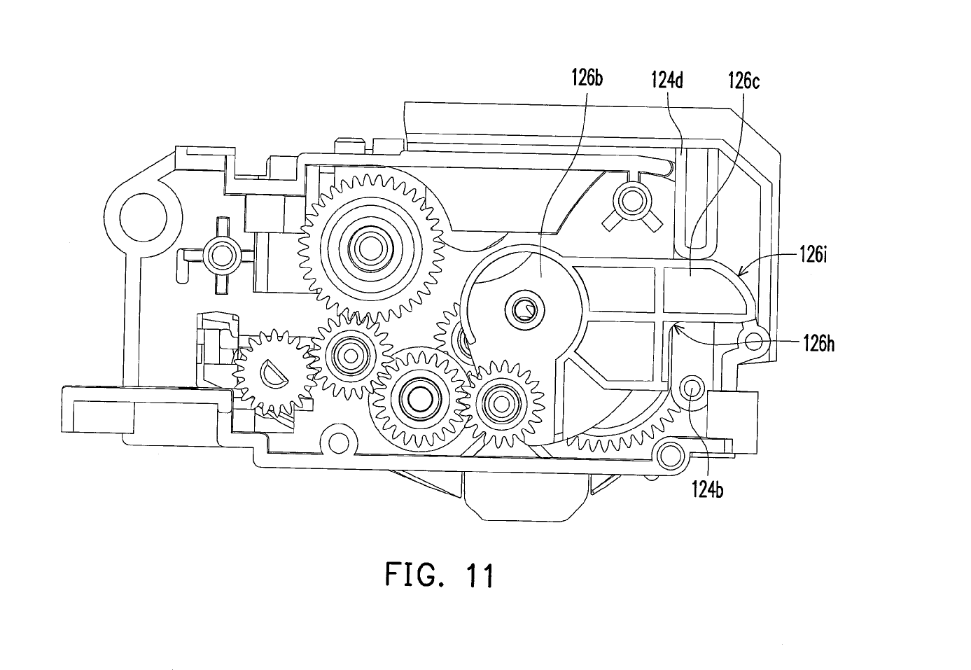

FIG. 11 is a schematic view illustrating an automatic document feeder with a cover is close according to a fourth embodiment. Referring to FIG. 11, the first rock arm 126c of the rotating unit 126b has an L-shaped opening 126h, and the cam is a shaft 124b. The location of the shaft 124b is not at the corner of the L-shaped opening 126h but disposed around the bottom (not shown) of the L-shaped opening 126h close to the main body 110. In other words, the shaft 124b distances from the corner of the L-shaped opening 126h.

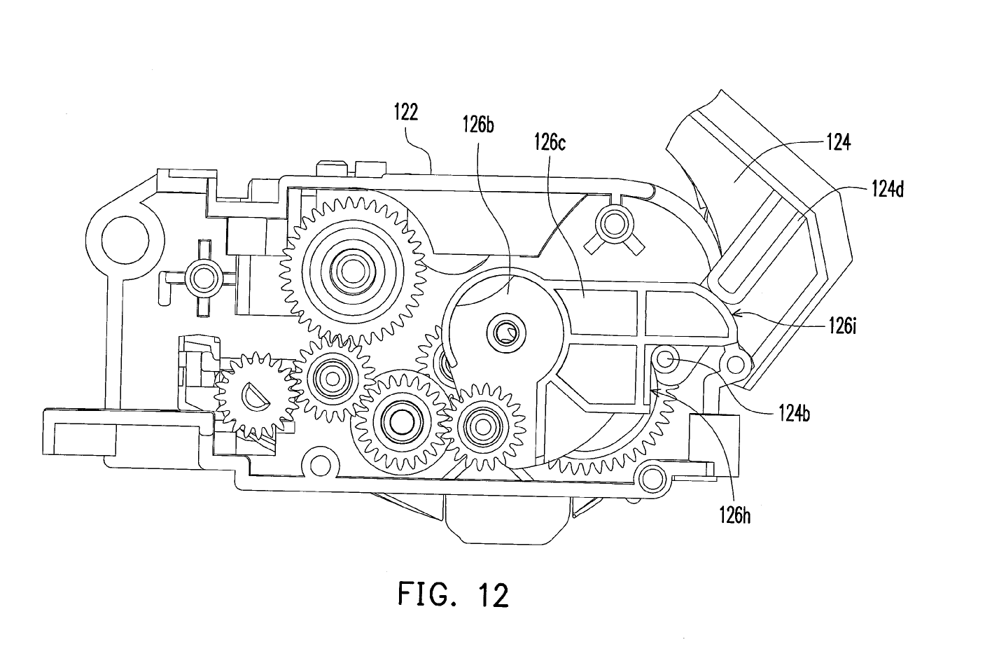

FIG. 12 is a schematic view illustrating the cover of the automatic document feeder according to a FIG. 11 is opening. Referring to FIGS. 11 and 12, along with an extent that the cover 124 opens relative to the frame 122, the shaft 124b moves along the profile of the L-shaped opening 126h to the corner of the L-shaped opening 126h.

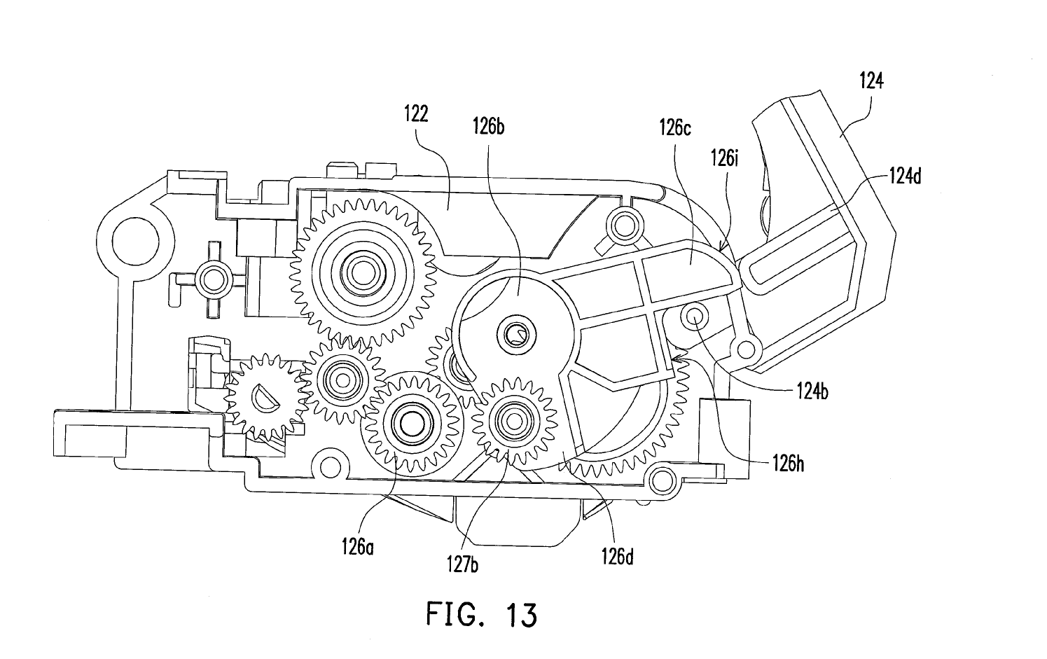

FIG. 13 is a schematic view illustrating the cover of the automatic document feeder according to a FIG. 12 is open. Referring to FIGS. 12 and 13, when the shaft 124b props against the corner of the L-shaped opening 126h, with the cover 124 continuously opens relative to the frame 122, the propping of the shaft 124b against the first rock arm 126c drives the rotating unit 126b to rotate, and therefore the engagement between the driven gear 126a and the driven gear 127b disposed on the second rock arm 126d is released.

Compared to the above embodiments, when the cover 124 starts to open relative to the frame 122, the shaft 124b serves as the cam would not drive the rotating unit 126b to rotate immediately, but the shaft 124b drive the rotating unit 126b to rotate after the shaft 124b moves forward for a distance and props against the first rock arm 126c, and thus the rotating unit 126b is driven to rotate.

After paper jam is released, in proper order of FIGS. 13, 12 to 11, cover 124 is close the relative to the frame 122. Specifically, a propping element 124d is disposed on the cover 124, and the first rock arm 126c has a guiding arc 126i. The propping element 124d moves smoothly relative to the guiding arc 126i along the profile of the guiding arc 126i when the cover 124 is in the situation of moving to open or to close relative to the frame 122 (such as the cover 124 is not completely opened).

In addition, the propping element 124d drives the rotating unit 126b to back to the original position completely. In detail, the propping element 124d moves relative to the guiding arc 126i along the profile of the guiding arc 126i when the cover 124 closes relative to the frame 122. When the cover 124 is back to the original position, the propping element 124d further props against the first rock arm 126c, the propping element 124d applies a normal force to the first rock arm 126c, and the rotating unit 126b is rotated back to the original position; thus, the driven gear 127b disposed on the second rock arm 126d rotated with the rotation of the rotating unit 126b engages with the driven gear 126a tightly again, and the gear chain (not shown) transmits power.

In summary, in the automatic document feeder and media record equipment using the same of the invention, the cam disposed on one end of the cover interferes with the rotating element. When the user opens the cover relative to the frame, the driven gear disposed on the second rock arm of the rotating element departs from the driven gear engaged therewith, and therefore a tight engagement between the driven gears of the gear chain is broken, then the rest of the driven gears have free rotating manner and the user can eject paper conveniently and labor-saved from the driven gears having free rotating manner. Since only one step that to open the cover, and therefore the cam disposed on the pivoted end of the cover drives the first rock arm of the rotating unit to depart from the driven gears, and thus the driven gears have free rotating manner, it is convenient and labor-saved for the user to release the paper from the gear chain.

Though the invention has been disclosed above by the embodiments, they are not intended to limit the invention. It will be apparent to one of ordinary skill in the art that modifications and variations to the described embodiments may be made without departing from the spirit and scope of the invention. Therefore, the protecting range of the invention falls in the appended claims.

What is claimed is:

1. An automatic document feeder, comprising:
a frame;
a cover, wherein an end of the cover is pivoted to the frame and therefore the cover can be open or close relative to the frame, and the end of the cover pivoted to frame has a cam;
a gear chain disposed in the frame, comprising:
a plurality of driven gears, wherein the driven gears disposed with the first axial direction as a rotating axle are engaged with each other; and
a rotating unit, disposed with the first axial direction as the rotating axle and having a first rock arm and a second rock arm, wherein the cam contacts the first rock arm and one of the driven gears is disposed on the second rock arm,
the cam pushes the first rock arm to drive the rotating unit to rotate about the first axial direction, and then an engagement between the driven gear disposed on the second rock arm and another driven gear engaged therewith is released by departing the driven gear disposed on the second rock arm from the driven gear engaged therewith when the cover opens relative to the frame.

2. The automatic document feeder as claimed in claim 1, wherein the first rock arm has an L-shaped opening, and the cam is located in the L-shaped opening when the cover is close to the frame.

3. The automatic document feeder as claimed in claim 2, wherein the cam is a shaft, and the shaft distances from the corner of the L-shaped opening when the cover is close to the frame.

4. The automatic document feeder as claimed in claim 3, wherein the cover has a propping element while the first rock arm has a first guiding arc, and the propping element props the first rock arm when the cover is close to the frame; the propping element moves along a profile of the guiding arc when the cover is open to the frame.

5. The automatic document feeder as claimed in claim 1, wherein the first rock arm has a U-shaped opening while the cam is a shaft, and the shaft is located in the U-shaped opening when the cover is close to the frame.

6. The automatic document feeder as claimed in claim 1, wherein the cam has a first tooth portion, the first rock arm has a second tooth portion, and the first tooth portion is engaged with the second tooth portion.

7. The automatic document feeder as claimed in claim 1, wherein the gear chain comprises a driving gear disposed with a second axial direction perpendicular to the first axial direction as the rotating axle, and the driving gear is engaged with one of the driven gears.

8. The automatic document feeder as claimed in claim 1, wherein the driven gear engaged with the driving gear is different from the driven gear disposed on the second rock arm.

9. The automatic document feeder as claimed in claim 1, wherein the frame has a plurality of fixing structures disposed around outside of the driven gears.

10. The automatic document feeder as claimed in claim 9, wherein the fixing structures are apertures.

11. The automatic document feeder as claimed in claim 9, further comprising a plurality of fixing units passing through the fixing structures individually.

12. The automatic document feeder as claimed in claim 1, further comprising an elastic element connected between the first rock arm and the frame.

13. The automatic document feeder as claimed in claim 12, wherein the elastic element is a spring or a rubber band.

14. The automatic document feeder as claimed in claim 12, each of a bottom of the frame and the first rock arm has a hook ring, and two ends of the elastic element connect to the hook rings individually.

15. A media record equipment, comprising:
a main body;
an automatic document feeder disposed on the main body, comprising:
a frame;
a cover, wherein an end of the cover is pivoted to the frame and therefore the cover could be open or close relative to the frame, and the end of the cover pivoted to the frame has a cam;
a gear chain, disposed in the frame and having a plurality of driven gears and a rotating unit, wherein the driven gears are engaged with each other and disposed with a first axial direction as the rotating axle, the rotating unit has a first rock arm and a second rock arm, the cam contacts the first rock arm and one of the driven gears is disposed on the second rock arm,
the cam pushes the first rock arm to drive the rotating unit to rotate about the first axial direction, and then an engagement between the driven gear disposed on the second rock arm and another driven gear engaged therewith is released by departing the driven gear disposed on the second rock arm from the driven gear engaged therewith when the cover opens relative to the frame.

16. The media record equipment as claimed in claim 15, wherein the first rock arm has an L-shaped opening, and the cam is located in the L-shaped opening when the cover is close to the frame.

17. The media record equipment as claimed in claim 16, wherein the cam is a shaft, and the shaft distances from the corner of the L-shaped opening when the cover is close to the frame.

18. The media record equipment as claimed in claim 17, wherein the cover has a propping element while the first rock arm has a first guiding arc, and the propping element props the first rock arm when the cover is close to the frame; the propping element moves along a profile of the guiding arc when the cover is open to the frame.

19. The media record equipment as claimed in claim 15, wherein the first rock arm has a U-shaped opening while the cam is a shaft, and the shaft is located in the U-shaped opening when the cover is close to the frame.

20. The media record equipment as claimed in claim 15, wherein the cam has a first tooth portion, the first rock arm has a second tooth portion, and the first tooth portion is engaged with the second tooth portion.

21. The media record equipment as claimed in claim 15, wherein the gear chain further comprises a driving gear disposed with a second axial direction perpendicular to the first axial direction as the rotating axle, and the driving gear is engaged with one of the driven gears.

22. The media record equipment as claimed in claim 15, wherein the driven gear engaged with the driving gear is different from the driven gear disposed on the second rock arm.

23. The media record equipment as claimed in claim 15, wherein the frame has a plurality of fixing structures disposed around outside of the driven gears.

24. The media record equipment as claimed in claim 23, wherein the fixing structures are apertures.

25. The media record equipment as claimed in claim 23, further comprising a plurality of fixing units passing through the fixing structures to fix the frame on the main body.

26. The media record equipment as claimed in claim 15, further comprising an elastic element connected between the first rock arm and the frame.

27. The media record equipment as claimed in claim 26, wherein the elastic element is a spring or a rubber band.

28. The media record equipment as claimed in claim 26, wherein each of a bottom of the frame and the first rock arm has a hook ring, and two ends of the elastic element connect to the hook rings individually.
